(19) United States
(12) Patent Application Publication
(10) Pub. No.: US 2012/0109381 A1
(43) Pub. Date: May 3, 2012

(54) WEB CONTROL SYSTEM FOR SOLAR TRACKING

(75) Inventors: Tae-won Choi, Suncheon-si (KR); Geon-min Kang, Suncheon-si (KR); Young-im Park, Muan-gun (KR)

(73) Assignees: UBITEK CO., LTD., Suncheon-si (KR); YOUIL ENSYS CO., LTD., Gyeonggi-do (KR)

(21) Appl. No.: 13/192,610

(22) Filed: Jul. 28, 2011

(30) Foreign Application Priority Data
Nov. 1, 2010 (KR) 10-2010-0107607

(51) Int. Cl. G05B 15/02

(52) U.S. Cl. 700/275

(57) ABSTRACT

A web control system for solar tracking includes one or more trackers, a communication port management unit, a status processing unit, a tracker control unit, a back tracking unit, a web server unit, and the memory unit. The trackers operate in compliance with driving commands and change the position of a solar cell panel in response to the tracking of the location of a sun. The communication port management unit is responsible for data transmission and reception. The status processing unit scans the status of the trackers. The tracker control unit directly controls the trackers. The back tracking unit analyzes the status information, and controls the tracker control unit. The local GUI interface unit displays a local or remote user screen. The web server unit provides the GUI data to a user. The memory unit stores the information.

### CROSS REFERENCE TO RELATED APPLICATIONS

This application claims the benefit of Korean Pat. Appl. No. 10-2010-0107607, filed Nov. 1, 2010, the entire contents of which are hereby incorporated by reference herein, for all purposes.

### TECHNICAL FIELD

The present invention relates generally to a web control system for solar tracking, which tracks the location of the sun and improves energy efficiency and, more particularly, to a web control system for solar tracking, which enables the operating status of trackers to be easily checked over the web, tracking errors to be corrected, and a shadow, produced by a structure (i.e., a solar cell panel), to be avoided by controlling the position using back tracking over the web, thereby improving the energy efficiency of photovoltaic power generation.

### BACKGROUND ART

In general, a photovoltaic power generation system is a power generation system for producing electricity by directly converting sunlight into electric power using solar cells. The photovoltaic power generation system includes the structure of a solar cell panel configured to have a solar cell plate mounted thereon, a sunlight tracking sensor configured to track the location of the sun, trackers configured to change the position of the structure in response to the tracking of a location of the sun, and a controller configured to control the driving of the trackers.

That is, in order to improve the efficiency of photovoltaic power generation, the position of the solar cell panel (i.e., structure) is controlled by controlling the positions of the trackers using the controller in accordance with changes in the location of sunlight.

A conventional photovoltaic power generation system, however, suffers from difficulty and inconvenience in checking the operating status of the trackers and performing control for each situation because the trackers are controlled only using the controller chiefly installed on a site, as described above and therefore on-site inspection is required.

In detail, the conventional photovoltaic power generation system has technical limitations because, in order to check an error in the location of the sun, an administrator must directly check the operating status of the trackers by means of on-site inspection with the naked eye and the trackers should be controlled in a very limited manner. Furthermore, the conventional photovoltaic power generation system is problematic in that the trackers cannot be quickly controlled in response to changes in the environment, such as weather conditions and the seasonal environment, energy efficiency is low because of low photovoltaic power generation efficiency attributable to lack of quick control, and the photovoltaic power generation system may be damaged.

### SUMMARY OF EMBODIMENTS

Accordingly, embodiments of the present invention have been made keeping in mind the above problems occurring in the prior art. An embodiment of the present invention provides a web control system for solar tracking, which enables the operating status of trackers to be easily checked over the web, tracking errors to be corrected, and a shadow, produced by a structure (i.e., a solar cell panel), to be avoided by controlling the position using back tracking over the web, thereby improving the energy efficiency of photovoltaic power generation.

Another embodiment of the present invention provides a web control system for solar tracking, which enables the operating status of trackers to be monitored over the web and the operation of the trackers to be controlled in real time, via a web browser locally or remotely, enables failures and errors to be fixed and corrected by checking the failures and the errors in the location tracking of the sun, and enables a shadow, produced by a structure (i.e., a solar cell panel), to be checked and avoided by performing time control based on the back tracking control of the trackers over the web in accordance with a seasonal environment.

Yet another embodiment of the present invention provides a web control system for solar tracking, which enables the operation of trackers to be immediately controlled over the web in case of an accident by controlling the operation of the trackers in association with the status information obtained by environmental sensors, such as a wind sensor, thereby enabling the trackers to be quickly controlled.

An embodiment of the present invention provides a web control system for solar tracking, including one or more trackers connected to the web control system, and configured to operate in compliance with driving commands generated by a controller, and to change the position of a solar cell panel on which solar cells are mounted in response to the tracking of the location of a sun; a communication port management unit configured to be responsible for data transmission and reception between the controller for controlling the operation of the trackers and a Data AcQuisition (DAQ) PC, that is, a local user PC; a status processing unit configured to scan the status of the trackers in specific cycles or in real time in regard to data received via the communication port management unit, and configured to store the scanned status in a memory unit, and to send the status information of the trackers to a local user screen or a remote user screen via a local Graphic User Interface (GUI) interface unit or a web server unit in real time; a tracker control unit configured to directly control the trackers via the communication port management unit, and to control the trackers while considering commands issued by a local user or a remote user via the local GUI interface unit or the web server unit; a back tracking unit configured to read the status information stored in the memory unit based on set status which is stored in the memory unit by setting of the local user or the remote user, to analyze current status of the trackers based the read status information, and to control the tracker control unit so that the tracker control unit sends back tracking control data; the local GUI interface unit configured to be driven by the DAQ PC, to have a GUI program for controlling the local or remote user screen installed therein, to display the local or remote user screen over a web, and to generally manage the web control system for solar tracking; a web server unit configured to receive GUI data for controlling the local or remote user screen from the local GUI interface unit, and to provide the GUI data for a web browser to the local or remote user who accesses the web server unit in an Internet environment; and the memory unit configured to store the status information or control information and the back tracking information related to the trackers.

The memory unit may include a status data memory unit configured to be managed by the status processing unit and to be a memory space for storing the status information of the trackers; a control data memory unit configured to be managed by the tracker control unit and to be a memory space for storing the control information about the trackers; and a back tracking information memory unit configured to be managed by the back tracking unit and to be a memory space for storing back tracking environment setting information set by the local or remote user.

Tilt sensors may be mounted on the trackers, and tilt data of the trackers, generated by the tilt sensors, may be processed by the status processing unit and monitored by the local or remote user via the communication port management unit, so that the local or remote user can check failures of the trackers or a tracking error in the location of the sun and then fix the failure or correct the tracking error over a web.

A wind sensor may be mounted on the trackers, and wind velocity data, generated by the wind sensor, may be processed by the status processing unit and monitored by the local or remote user via the communication port management unit, so that the local or remote user can control the trackers over a web based on the wind velocity data sent from the wind sensor.

### BRIEF DESCRIPTION OF THE DRAWINGS

The invention will be more fully understood by referring to the following Detailed Description of Specific Embodiments in conjunction with the Drawings, of which:

FIG. 1 is a block diagram showing the configuration of a web control system for solar tracking according to an embodiment of the present invention;

FIG. 2 is a block diagram showing the configuration of a web control system for solar tracking according to another embodiment of the present invention;

FIG. 3 is a diagram showing an example of a tracker status window displayed on a user web screen via the web control system for solar tracking according to an embodiment of the present invention;

FIG. 4 is a diagram showing an example of the current operating status of a tracker via a tracker status window which is displayed on a user web screen via the web control system for solar tracking according to an embodiment of the present invention;

FIG. 5 is a diagram showing an example of a tracker status window and a tracker setting input window which are displayed on a user web screen via the web control system for solar tracking according to an embodiment of the present invention; and

FIG. 6 is a diagram showing an example of a back tracking setting pop-up window which is displayed to allow the back tracking of a tracker to be set according to an embodiment of the present invention.

### DETAILED DESCRIPTION OF SPECIFIC EMBODIMENTS

Embodiments of the present invention will be described in detail below with reference to the accompanying drawings. The objects, configuration and characteristics of these embodiments will be more fully understood from the following detailed description.

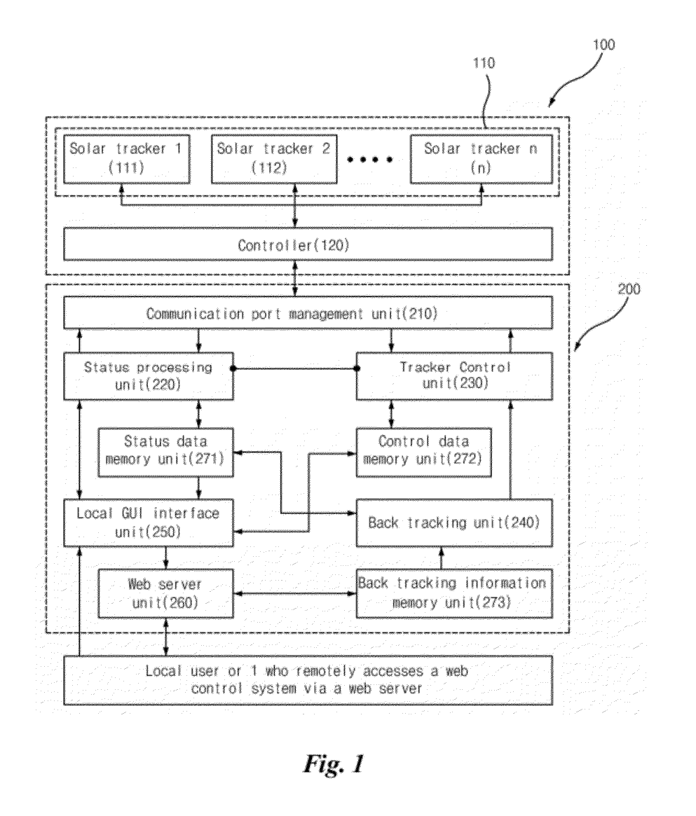

As shown in FIG. 1, a web control system 200 for solar tracking according to an embodiment of the present invention is based on a photovoltaic power generation system 100. The photovoltaic power generation system 100 includes one or more trackers 110 which are driving units for changing the position of a solar cell panel on which solar cells are mounted in response to the tracking of the location of the sun and which are controlled in response to driving commands generated by a controller 120. A local or remote user 1 can efficiently control the solar tracking operation of the trackers 110 using the above-described configuration over the web.

The web control system 200 for solar tracking according to an embodiment of the present invention includes a communication port management unit 210, a status processing unit 220, a tracker control unit 230, a back tracking unit 240, a local Graphic User Interface (GUI) interface unit 250, a web server unit 260, a status data memory unit 271, a control data memory unit 272, and a back tracking information memory unit 273. The communication port management unit 210 is responsible for the transmission and reception of data between a Data AcQuisition (DAQ) PC (i.e., a local user PC) and the controller 120 for controlling the operation of the trackers 110. The status processing unit 220 scans the status of the trackers 110 in specific cycles or in real time in regard to data received through the communication port management unit 210, stores the scanned status in the status data memory unit 271, and sends information about the status of the trackers 110 to a local user screen or a remote user screen via the local GUI interface unit 250 or the web server unit 260 in real time. The tracker control unit 230 directly controls the trackers 110 using the communication port management unit 210, but controls the trackers 110 while considering a command issued by the local user or the remote user via the local GUI interface unit 250 or the web server unit 260. The back tracking unit 240 reads data stored in the status data memory unit 271 based on set status stored in the back tracking information memory unit 273 according to the settings of the local user or the remote user, analyzes the current status of the trackers 110 based the read data, and controls the tracker control unit 230 so that it sends back tracking control data. The local GUI interface unit 250 is driven on the DAQ PC (i.e., a local user PC), is provided with a GUI program for controlling the user screen so that the user screen can be displayed over the web, and generally manages the web control system for solar tracking. The web server unit 260 receives GUI data for controlling the user screen from the local GUI interface unit 250, and provides the GUI data for an HTML-based web browser to the local or remote user 1 who gains access in an Internet-based environment. The status data memory unit 271 is managed by the status processing unit 220, and functions as a memory space for storing the status information of the trackers 110. The control data memory unit 272 is managed by the tracker control unit 230, and is a memory space for storing control information for the trackers 110. The back tracking information memory unit 273 is managed by the back tracking unit 240, and is a memory space for storing back tracking environment setting information set by the local or remote user 1.

The communication port management unit 210 is a communication port which enables the transmission and reception between the DAQ PC and the controller 120 for controlling the operation of the trackers. A variety of communication methods and communication interfaces may be applied to the communication port management unit 210. In embodiments of the present invention, the communication port management unit 210 is equipped with a serial converter so that serial communication is possible.

The local GUI interface unit 250 enables information exchange with the DAQ PC via graphics or information exchange with the local user 1 or the remote user 1 who makes access via the web server unit 260. The local GUI interface unit 250 supports a working environment in which a local or remote user 1 can perform tasks by selecting options from menus displayed on a screen over the web using the mouse, rather than performing tasks by inputting commands using the keyboard.

In detail, the application of the GUI enables the local or remote user 1 to exchange information with a computer using icons, to perform operations by controlling the screen, and to easily use the mouse, thereby being able to easily control the computer, with the result that tracking web control can be quickly performed and also user convenience can be provided.

The web control system for solar tracking according to an embodiment of the present invention is operated by the local user 1 who uses the DAQ PC or the remote user 1 who remotely accesses the web control system for solar tracking via the web server unit 260. Accordingly, the local or remote user 1 can monitor the overall operating status of the trackers 110 using the screen in a web environment, and remotely control the one or more trackers 110 individually or collectively by controlling a screen.

Although not shown, each of the trackers 110 of the photovoltaic power generation system 100 includes a solar cell panel configured to have solar cells mounted thereon and a sun tracking sensor installed on the solar cell panel and configured to track the location of the sun.

A number of controllers 120 equal to the number of the trackers 110 may be installed to control the individual trackers 110, or a single controller 120 may be installed to control the trackers 110 in an integrated fashion.

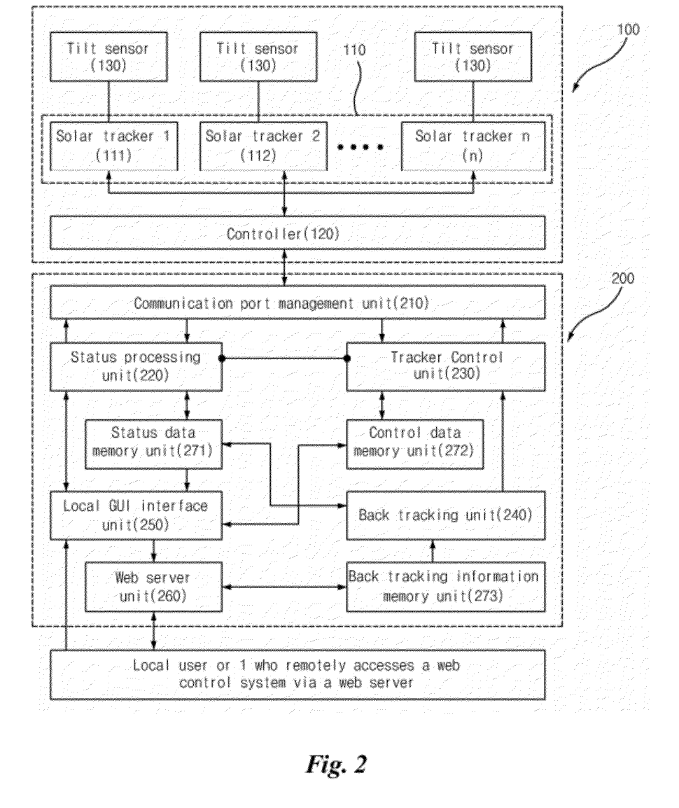

Furthermore, as shown in FIG. 2, tilt sensors 130 may be mounted on the trackers 110, and the tilt (i.e., angular) data of the trackers 110, generated by the tilt sensors 130, may be processed by the status processing unit 220 and monitored by the local or remote user 1 via the controller 120 and the communication port management unit 210. In this case, the local or remote user 1 can check the failure of the trackers 110 or an error in the location tracking of the sun, and fix the failure and correct the tracking error over the web.

A wind sensor 140 may be further mounted on the trackers 110, and wind velocity data, generated by the wind sensor 140, may be processed by the status processing unit 220 and monitored by the local or remote user 1 via the controller 120 and the communication port management unit 210. In this case, the local or remote user 1 may control the trackers 110 over the web so as to stabilize the photovoltaic power generation system when a data value received from the wind sensors 140 is equal to or higher than a set value.

The wind sensor 140 may not necessarily be mounted on the trackers 110, but may be installed in a power plant in which the power generation system is installed.

The operation of the web control system for solar tracking according to an embodiment of the present invention will now be described.

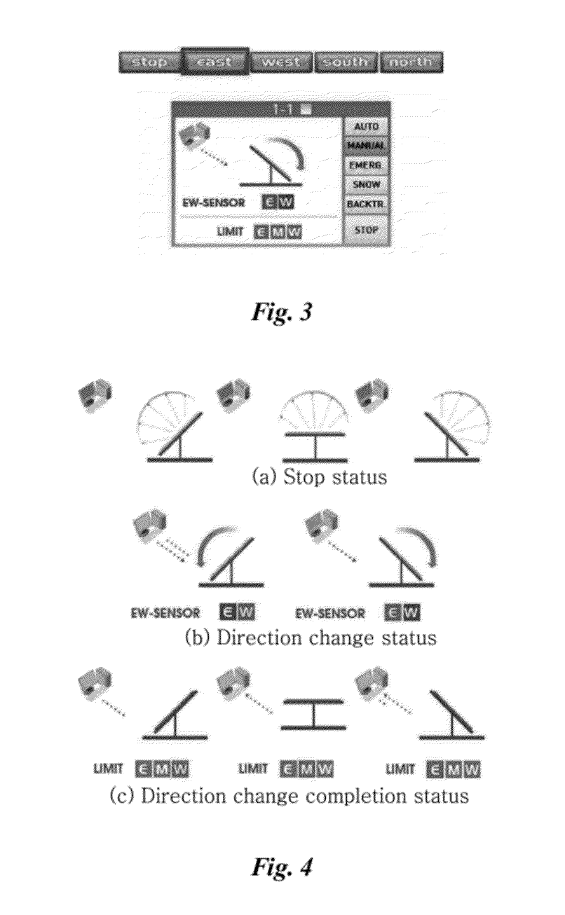

When the local or remote user 1 accesses the web control system 200 for solar tracking according to an embodiment of the present invention via the web server unit 260, the status of the trackers 110 of the photovoltaic power generation system 100 installed in the power plant is displayed on a screen of the user in the form of an image, as shown in FIG. 3.

Here, in order to access the web control system 200 for solar tracking according to an embodiment of the present invention, the user 1 enters a web address, and then accesses the web control system 200 by performing a login process by entering an ID and a password.

In the web control system 200 for solar tracking, the communication port management unit 210 receives various types of data for controlling the photovoltaic power generation system 100 (i.e., controlling the operation of the trackers 110) from various sensors, such as the sun tracking sensors, the tilt sensors and the wind sensor, via the controller 120 of the trackers 110, and sends the various types of data to the status processing unit 220. The status processing unit 220 scans the status of the trackers 110 using the received data, and sends the status information of the trackers 110 to the web server unit 260 via the local GUI interface unit 250 in real time. Thereafter, a tracker status window activated as shown in FIG. 3 is displayed on the screen of the local user or the remote user who gains access in an Internet-based environment.

Furthermore, all the pieces of status information of the trackers 110 which are scanned by the status processing unit 220 are stored in the status data memory unit 271 after being managed by the status processing unit 220.

As described above, the pieces of status information of the trackers 110, transmitted by the status processing unit 220 in real time, and the GUI program for controlling the user screen, installed in the local GUI interface unit 250, interact with each other and configure a screen. As shown in FIG. 3, icons, such as direction control buttons, mode change buttons, and a tracker choice/release check box, are displayed on the user screen along with an image of the current operating status of the trackers 110, and therefore a screen is provided such that the local or remote user may easily control the trackers 110 over the web by controlling the screen.

In the web control system 200 for solar tracking according to an embodiment of the present invention, a number of tracker images equal to the number of the trackers 110 installed in the power plant may be displayed on the user screen.

As described above, the local or remote user 1 may perform direction control, a mode change, tracker choice and release for individual or group control, tracker setting, back tracking setting, and tracker control in an emergency mode on the one or more trackers 110 installed in the power plant via the tracker status window displayed on the screen of the local or remote user. The user can control the trackers 110, installed in the power plant, over the web.

FIG. 4 is a diagram showing an example of the current operating status of the tracker 110 that is displayed on the user screen via the web control system 200 for solar tracking according to an embodiment of the present invention.

As shown in FIG. 4, according to embodiments of the present invention, the local or remote user 1 may easily check the current operating status of the trackers 110, installed in the power plant, via a web screen accessed via the web server unit 260.

That is, the user 1 may check the current operating status of each of the trackers 110, installed in the power plant, via an image of the tracker 110 formed using the status processing unit 220 and the local GUI interface unit 250. If a gray-based image, such as that of 4(a), is displayed, it indicates that the status of the tracker is stop status. If an arrow is displayed, as shown in 4(b), it indicates that the tracker is moving in the direction of the arrow. If a red image is displayed, as shown in 4(c), it indicates that the movement of the tracker has been terminated.

Here, the user 1 who has accessed the web control system for solar tracking according to embodiments of the present invention checks the tilt state (angle) of each tracker 110 on a date and at a time in a corresponding season by checking the current operating status of the tracker 110, such as that shown in FIG. 4, thereby being able to diagnose the failure of the tracker 110 and an error in the location tracking of the sun using the image of the tracker 110.

As an example, when the tracker should be tilted at an angle of 45° in accordance with a standard based on a date and a time for a corresponding season but is actually in a horizontal position at 0°, the local or remote user 1 diagnoses the tracker as having failed, stops the operation of the tracker, and performs on-site inspection on the tracker.

Furthermore, when the tracker should be tilted at an angle of 30° in accordance with a standard based on a date and a time for a corresponding season but is actually tilted at an angle of 20°, the local or remote user 1 needs only to select an image of the relevant tracker using the tracker choice/release check box in a tracker status window on a web screen, such as that shown in FIG. 3 and to click on a direction control button, thereby moving the tracker in a desired direction and at a desired angle.

Here, the trackers 110 may be selectively controlled through the user screen by controlling the trackers individually or collectively via the tracker choice/release check box in the tracker status window, such as that shown in FIG. 3.

As described above, when various commands for controlling the trackers 110 installed in the power plant individually or collectively are issued by the local or remote user 1 based on images of the trackers 110 displayed on a web screen, the tracker control unit 230 collects the commands of the user and sends them to the controller 120, thereby allowing the controller 120 to directly control the trackers 110. Furthermore, the tracker control unit 230 stores control information, generated by the manipulation of the user, in the control data memory unit 272.

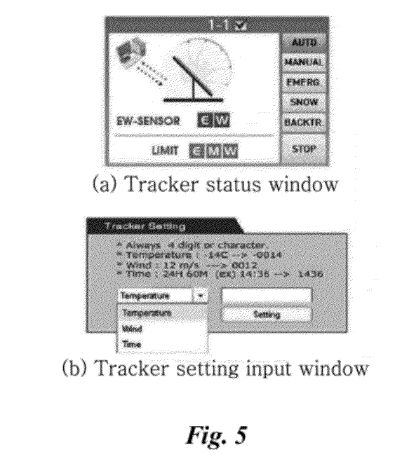

FIG. 5 is a diagram showing an example of a tracker status window and a tracker setting input window which are displayed on the user screen via the web control system 200 for solar tracking according to an embodiment of the present invention. This diagram is provided to illustrate the input of tracker setting information which enables the user to perform an automatic mode for the trackers and to input a reference setting value which will be associated with status information provided by environmental sensors, such as the wind sensor.

That is, when the local or remote user checks off the mode choice button and the tracker choice/release check box in a tracker status window (refer to FIG. 5(a)) displayed on a web screen, the tracker setting input window, such as that shown in FIG. 5(b), is displayed. When the local or remote user selects temperature, wind velocity, or the time in the tracker setting input window and then enters a set reference value, the setting of the trackers is completed. The tracker control unit 230 performs control so that the value, entered by the local or remote user, is stored and managed in the control data memory unit 272, and the value will be used to control the trackers.

For example, the wind sensor 130 may be installed on the trackers 110 or in a power plant and connected to the web control system 200 of an embodiment of the present invention so that the window sensors 130 can operate in conjunction with the web control system 200. When the local or remote user enters a set reference value of the wind sensor 140 for a relevant tracker 120 via a web screen, the status processing unit 220 processes a data value sent to the web control system 200 by the wind sensor 140. If the data value received from the wind sensor 140 is greater than the set reference value entered by the local or remote user, the tracker control unit 230 performs automatic control so that the tracker 120 is in a horizontal position, and controls the tracker 120 so that it waits without operating in the horizontal position. Accordingly, the photovoltaic power generation system 100 can be stabilized and prevented from being damaged.

Meanwhile, web control may be performed in a plurality of modes which can be selected using the mode change button in the tracker status window which is displayed on a web screen, such as that shown in the drawing. When a manual mode is selected, the local or remote user can change the control mode of the trackers 110 to the manual mode, manipulate a screen in a desired form, and control the trackers 110. In an emergency mode, in case of bad weather, such as a typhoon or a blast, the trackers 110 may be controlled in a manner similar to the operation of conjunction with the wind sensor 140. When a lot of snow falls, automatic control may be performed so that the trackers 110 are tilted at an angle of 45° by clicking on snow mode.

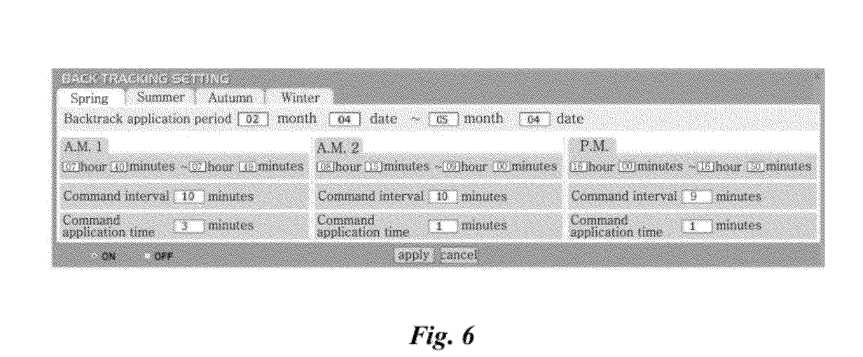

Furthermore, when back tracking mode is clicked on, a back tracking setting pop-up window is displayed as shown in FIG. 6, and the trackers 110 may be controlled by setting back tracking for the trackers 110 so that the local or remote user can control the trackers 110 for each season or each time over the web.

Here, the back tracking setting information set by manipulating the user screen via the back tracking pop-up window is stored in the back tracking information memory unit 273 under the control of the back tracking unit 240. The back tracking unit 240 reads the status data memory unit 271, analyzes the current status of the trackers 110 based on the stored setting status, and then sends the back tracking control data to the tracker control unit 230, thereby performing back tracking control on the trackers 110.

The back tracking control of the trackers 110 based on the back tracking setting enables the user to control the trackers 110 so that a shadow produced by the solar cell panel (i.e., structure) can be avoided by time control in accordance with a change in the environment. Accordingly, energy efficiency and generation efficiency related to photovoltaic generation can be significantly improved.

In detail, the local or remote user may perform the back tracking control of the trackers 110 capable of improving energy efficiency and generation efficiency by performing seasonal setting, morning operation setting, and afternoon operation setting in accordance with a change in the environment via the back tracking setting pop-up window, such as that shown in FIG. 6.

That is, in some embodiments, the local or remote user may set a back tracking application period for each season, such as spring, summer autumn, and winter. If the morning operation and the afternoon operation are set, the local or remote user may set an operation duration (i.e., a start time and an end time), a command interval (i.e., an interval at which a back tracking command is sent), and a command application time (i.e., a direction command duration). The back tracking unit 240 manages such settings, and sends the back tracking control data to the tracker control unit 230 in accordance with user setting.

Here, the tracker control unit 230 sends a signal to the controller 120 in response to a signal from the back tracking unit 240, thereby starting back tracking at the back tracking start time. The trackers 110 are moved only for the command application time during the command interval, but are stopped for the remaining time. When the back tracking end time has elapsed, the back tracking operation is terminated.

Embodiments of the present invention have the advantage of significantly improving energy efficiency and generation efficiency related to photovoltaic power generation because these embodiments enable a local or remote user to easily check the operating status of the trackers installed in a power plant over the web, to correct the tracking errors of the trackers by manipulating the user screen on a web screen, to diagnose and control failures by checking the operating status of the trackers, and to perform the back tracking of the trackers based on time control for each season and each time in accordance with a change in the environment by manipulating the screen over the web, thereby avoiding a shadow produced by the structure (i.e., the solar cell panel).

Furthermore, embodiments of the present invention have the advantage of quickly controlling, in case of an accident, the operation of the trackers installed in a power plant by manipulating the screen because the operation of the trackers can be controlled in association with the status information of environmental sensors, such as the wind sensor.

The disclosed web control system for solar tracking may include a processor controlled by instructions stored in a memory. The memory may be random access memory (RAM), read-only memory (ROM), flash memory or any other memory, or combination thereof, suitable for storing control software or other instructions and data. Some of the functions performed by the web control system for solar tracking have been described with reference to flowcharts and/or block diagrams. Those skilled in the art should readily appreciate that functions, operations, decisions, etc. of all or a portion of each block, or a combination of blocks, of the flowcharts or block diagrams may be implemented as computer program instructions, software, hardware, firmware or combinations thereof Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the inventive concepts disclosed herein. For example, although some aspects of web control system for solar tracking have been described with reference to a flowchart, those skilled in the art should readily appreciate that functions, operations, decisions, etc. of all or a portion of each block, or a combination of blocks, of the flowchart may be combined, separated into separate operations or performed in other orders. Furthermore, disclosed aspects, or portions of these aspects, may be combined in ways not listed above.

Although the embodiments of the present invention have been disclosed for illustrative purposes, those skilled in the art will appreciate that various modifications, additions and substitutions are possible, without departing from the scope and spirit of the invention as disclosed in the accompanying claims. Accordingly, the invention should not be viewed as being limited to the disclosed embodiments.

What is claimed is:

1. A web control system for solar tracking, comprising:
at least one tracker connected to the web control system and configured to operate in compliance with driving commands generated by a controller and to change a position of a solar cell panel on which solar cells are mounted in response to tracking of a location of a sun;
a communication port management unit configured to be responsible for data transmission and reception between the controller for controlling operation of the trackers and a Data AcQuisition PC (DAQ PC);
a status processing unit configured to scan status of the at least one tracker in at least one of specific cycles and in real time in regard to data received via the communication port management unit, the status processing unit being configured to store the scanned status in a memory unit and to send the status information of the at least one tracker to at least one of a local user screen and a remote user screen via at least one of a local Graphic User Interface (GUI) interface unit and a web server unit in real time;
a tracker control unit configured to directly control the at least one tracker via the communication port management unit and to control the at least one tracker while considering commands issued by at least one of a local user and a remote user via at least one of the local GUI interface unit and the web server unit;
a back tracking unit configured to read the status information stored in the memory unit based on set status, which is stored in the memory unit by setting of at least one of the local user and the remote user, to analyze current status of the at least one tracker based the read status information and to control the tracker control unit so that the tracker control unit sends back tracking control data;
wherein the local GUI interface unit is configured to be driven by the DAQ PC, to have a GUI program for controlling at least one of the local and remote user screen installed therein, to display at least one of the local and remote user screen over a web, and to generally manage the web control system for solar tracking; further comprising:
a web server unit configured to receive GUI data for controlling at least one of the local and remote user screen from the local GUI interface unit and to provide the GUI data for a web browser to at least one of the local and remote user who accesses the web server unit in an Internet environment; and
wherein the memory unit is configured to store at least one of the status information and control information and the back tracking information related to the at least one tracker.

2. The web control system according to potential claim 1, wherein the memory unit comprises:
a status data memory unit configured to be managed by the status processing unit and to store the status information of the at least one tracker;
a control data memory unit configured to be managed by the tracker control unit and to store the control information about the at least one tracker; and
a back tracking information memory unit configured to be managed by the back tracking unit and to store back tracking environment setting information set by at least one of the local and remote user.

3. The web control system as set forth in claim 1, further comprising:
a plurality of tilt sensors mounted on the at least one tracker; and wherein:
tilt data of the at least one tracker, generated by the plurality of tilt sensors, is processed by the status processing unit and monitored by at least one of the local and remote user via the communication port management unit, so that at least one of the local and remote user can check at least one of failures of the at least one tracker and a tracking error in the location of the sun and then fix the failure or correct the tracking error, as the case may be, over a web.

4. The web control system as set forth in claim 1, further comprising:
a wind sensor mounted on the at least one tracker; wherein:
wind velocity data, generated by the wind sensor, is processed by the status processing unit and monitored by at least one of the local and remote user via the communication port management unit, so that at least one of the local and remote user can control the at least one tracker over a web based on the wind velocity data sent from the wind sensor.
